(19) United States
(12) Patent Application Publication
(10) Pub. No.: US 2007/0165416 A1
(43) Pub. Date: Jul. 19, 2007

(54) Vehicular headlamp

(75) Inventors: Hiroyuki Ishida, Shizuoka-shi (JP); Syoji Yoshida, Shizuoka-shi (JP); Masao Okawa, Shizuoka-shi (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/649,527

(22) Filed: Jan. 4, 2007

(30) Foreign Application Priority Data
Jan. 13, 2006 (JP) 2006-005492

(51) Int. Cl. B60Q 1/26

(52) U.S. Cl. 362/487

(57) ABSTRACT

In a headlamp providing a predetermined light distribution pattern by combining illumination light beams that are respectively emitted from a plurality of light source units LU1 to LU4 each of which using a light emitting element as the light source, at least one of the plurality of light source units being a light source unit that forms a hot zone in the light distribution pattern, the lamp center being provided within a light emission area of the light source unit LU1 that forms the hot zone, and a center mark CM that indicates the lamp center being provided on the front cover of the lamp.

### BACKGROUND OF THE INVENTION

1. Field of the Invention

The present invention relates to a vehicular headlamp that includes a plurality of light source units and more particularly to a vehicular headlamp of which lamp center can be detected with a high level of precision.

2. Description of the Related Art

Headlamps for automobiles include a low-beam lamp in which the optical axis is directed downward so as to provide a predetermined light distribution pattern that prevents drivers in oncoming traffic from betting getting blinded. For such a low-beam lamp, a test called a head light test is performed using a head light testing apparatus. This head light test is to see if the low-beam lamp is directed toward a predetermined direction and to see if the low-beam lamp satisfies a predetermined light distribution pattern or not. In this test, it is necessary to detect a reference position for each lamp (called a “lamp center”) so that the lamp center is positioned and aligned with a light distribution pattern tester of the head light testing apparatus.

More specifically, a head light testing apparatus receives a light beam emitted from each headlamp, takes an image of the received light beam with an imaging device, performs a signal processing on an image signal obtained in the imaging process so as to recognize a light distribution pattern, and then detects the position of a cut-off line in the light distribution pattern. The lamp center is next detected based on the detected cut-off line in order to judge if the lamp center is located at the predetermined position or not.

In a conventional low-beam lamp that uses a single incandescent bulb or a single discharge bulb, the position of the bulb is a lamp center of such a lamp; as a result, it is possible to directly specify the lamp center from the bulb position. For such a conventional low-beam lamp, when the lamp center is detected using a head light testing apparatus, substantially the center of an area in which the light radiated from the lamp has been received, i.e. substantially the center of a light emission area, is detected as the lamp center. In the technique disclosed in Japanese Utility Model Application Laid-Open (Kokai) No. 4-2401, a reflective portion is provided at a center position of the lens provided on the front face of a lamp, and the lamp center is detected by irradiating light from the front side of the lamp and detecting the light beam reflected by the reflective portion.

Recently, headlamps that include light source units in which a semiconductor light emitting element(s) is used as the light source have been proposed. In headlamps of such a type, since the quantity of light of each light source unit is small, a plurality of light source units are used in combination so as to obtain a required or predetermined quantity of light; and at the same time, the radiation areas of each one of the light source units are configured so as to be mutually different so that a required or predetermined light distribution pattern can be obtained by combining the radiation areas. For example, in U.S. Pat. No. 6,882,110, a low-beam lamp is configured with a plurality of light source units, and it includes a light source unit for forming a cut-off line, a light source unit for forming a hot zone, and a light source unit for forming other diffusion region. The “cut-off line” refers to a line that defines an illumination area for preventing drivers in the oncoming traffic from getting blinded, and the “hot zone” is an area in front of the vehicle along the cut-off line. In such a low-beam lamp, the lamp center is set to be at substantially the center of the light source unit that forms the hot zone.

In such a lamp that includes a plurality of light source units (called a “multi-light source type lamp”), it is difficult to detect the lamp center because a light beam is emitted from each of the plurality of light sources. In other words, when a head light testing apparatus receives the light beams emitted from the multi-light-source type lamp, since the light beams are respectively received from the plurality of light source units, the head light testing apparatus is not able to judge which one of the light beams received from the light source units should be used to specify the lamp center of the lamp. When a light testing apparatus that automatically detects the lamp center is used, if the testing apparatus recognizes the light beams from the plurality of light source units as one light emission, then the testing apparatus recognizes the physical center of the light emission area or the center of a luminance distribution as the lamp center. In particular, when, as in low-beam lamps, a light distribution pattern is not point-symmetric and the central area of the light distribution pattern is defined as a hot zone, the light testing apparatus erroneously recognizes the center of the light emission area or the center of a high-luminance area as the lamp center, so that the light testing apparatus detects the lamp center at a different position from the specified or true lamp center. Even if a reflective part is provided at the center of the lens as in Japanese Utility Model Application Laid-Open (Kokai) No. 4-2401, it is not possible to detect or locate the lamp center as the center of the light distribution pattern, though it can detect the center position of the lamp.

### BRIEF SUMMARY OF THE INVENTION

Accordingly, it is an object of the present invention to provide a vehicular headlamp in which the headlamp is a multi light-source type lamp and a detection of the lamp center can be made with a high level of precision.

The above object is accomplished by a unique structure of the present invention for a vehicular headlamp that includes a plurality of light source units having respectively a light emitting element as a light source thereof and being configured so as to provide a predetermined light distribution pattern by combining illumination light beams respectively emitted from said plurality of light source units; and in the present invention,
at least one of the plurality of light source units forms a hot zone in the light distribution pattern;
a lamp center is provided within the light emission area of such an at least one of the plurality of light source units that forms the hot zone; and
   the vehicular headlamp is further provided with a center mark indicative of the lamp center.

In the present invention, when one of the plurality of light source units forms the hot zone, the lamp center is set at the position of the optical axis of such one of the plurality of light source units. On the other hand, when the plurality of light source units form the hot zone, then the lamp center is set at the center of the light emission area of such plurality of light source units. When the light source unit(s) that forms the hot zone is a projector-type light source unit that has a front lens, substantially the center of the front face of the lens is specified as the lamp center.

In the present invention, the center mark can be comprised of a reflective member provided on the front face (front cover) of the vehicular headlamp and at a position that corresponds the lamp center.

Furthermore, a plurality of guide marks can be disposed in the perimeter area of the front face of the vehicular headlamp so that the lamp center is located at an intersection point of line segments that pass through these guide marks, so that the center mark is provide the thus obtained lamp center.

In addition, in the vehicular headlamp of the present invention the center mark can be a marking member which is attachable on and detachable from the front face (front cover) of the lamp.

As seen from the above, in the present invention, the center mark that is provided on the headlamp; and by way of automatically detecting or visually recognizing the center mark and by way positioning and aligning the optical axis of an imaging device of a head light testing apparatus with the center mark, it is possible, even if the headlamp includes multiple light source units, to detect and locate, with a high level of precision, the center of the light emission area of one or more light source units that form the hot zone; and especially for a low-beam light distribution pattern, it is possible to detect and locate, with a high level of precision, an elbow point in the low-beam light distribution pattern. Thus, in the headlamp according to the present invention, accurate tests of light distribution patterns can be performed.

### BRIEF DESCRIPTION OF THE SEVERAL VIEWS OF THE DRAWINGS

FIG. 1 is a perspective view of the exterior of the headlamp according to one embodiment of the present invention;

FIG. 2A is a schematic perspective view of one of the projector-type light source units of the lamp of FIG. 1, FIG. 2B is a schematic vertical cross sectional view thereof, and FIG. 2C is a schematic front view of the reflectors thereof;

FIG. 3A is a schematic perspective view of a diffusion-type light source unit installed in the lamp of FIG. 1, and FIG. 2B is a schematic vertical cross sectional view thereof;

FIGS. 4A through 4E illustrates the low-beam pattern and the radiation areas of the respective light source units installed in the lamp of FIG. 1;

FIG. 5A is a front view of the headlamp of FIG. 1, and FIG. 5B is an enlarged cross-sectional view of the relevant part taken along the line VB-VB in FIG. 5A;

FIG. 6 is a conceptual diagram of a head light testing apparatus used for the lamp of the present invention;

FIG. 7 is a front view of the imaging device of the head light testing apparatus of FIG. 6;

FIG. 8 is a front view of the headlamp according to another embodiment of the present invention;

FIGS. 9A and 9B are, respectively, cross-sectional side views of the relevant parts of the headlamp according to still another embodiment of the present invention;

FIG. 10A shows a reflection assisting member according to the present invention, and FIG. 10B shows the reflection assisting member attached to the headlamp of the present invention; and

FIGS. 11A through 11C illustrate different modes of the lamp centers according to the present invention.

### DETAILED DESCRIPTION OF THE INVENTION

Embodiments of the present invention will be described with reference to the accompanying drawings.

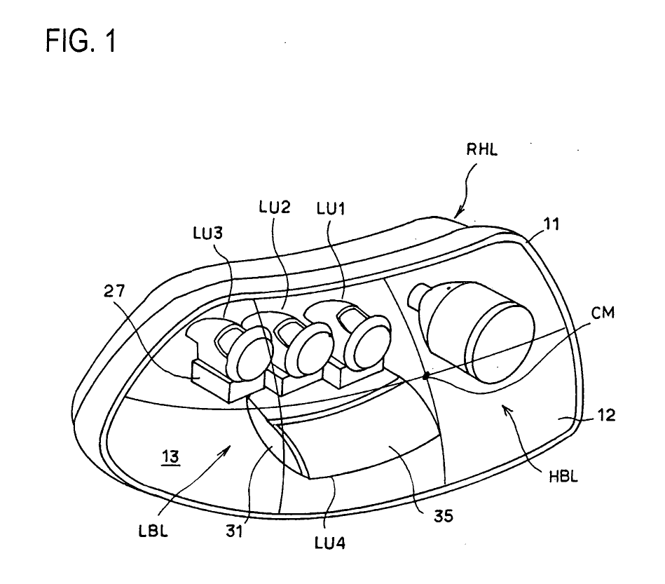

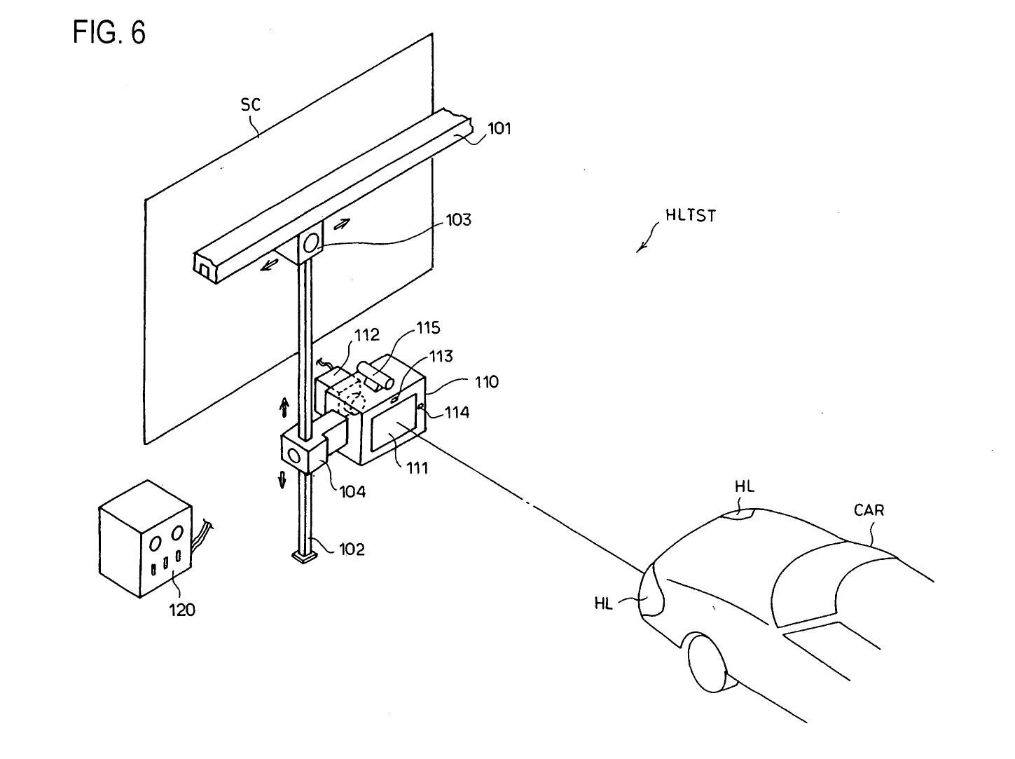

FIG. 1 shows the right-side headlamp RHL, which is one of the pair of headlamps HL (see FIG. 6) mounted on the left and right sides of the front part of an automobile to which the present invention is applied. The lamp chamber 13 of this headlamp is made up of, at least, a lamp body 11 and a transparent cover 12 attached to the front opening of the lamp body 11; and a high-beam lamp HBL and a low-beam lamp LBL are installed in this lamp chamber 13.

The high-beam lamp HBL is a single, projector-type lamp that uses a discharge bulb as its light source. Because such a projector-type lamp that uses a discharge bulb as the light source is already well known, a detailed explanation thereon will be omitted.

The low-beam lamp LBL is a multiple light-source type lamp that includes a plurality of light source units; and in the shown embodiment, the low-beam lamp LBL is comprised of four light source units LU1 to LU4 that are arranged in a row, and each of the light source units uses a semiconductor light emitting element as the light source.

Of the four light source units LU1 to LU4, three are projector-type light source units LU1 to LU3, and one is a diffusion-type light source unit LU4. The projector-type light source units LU1 to LU3 are disposed in the upper portion of the lamp chamber 13 and arranged horizontally in a row. The diffusion-type light source unit LU4 is disposed in the lower portion or under the projector-type light source units LU1 to LU3.

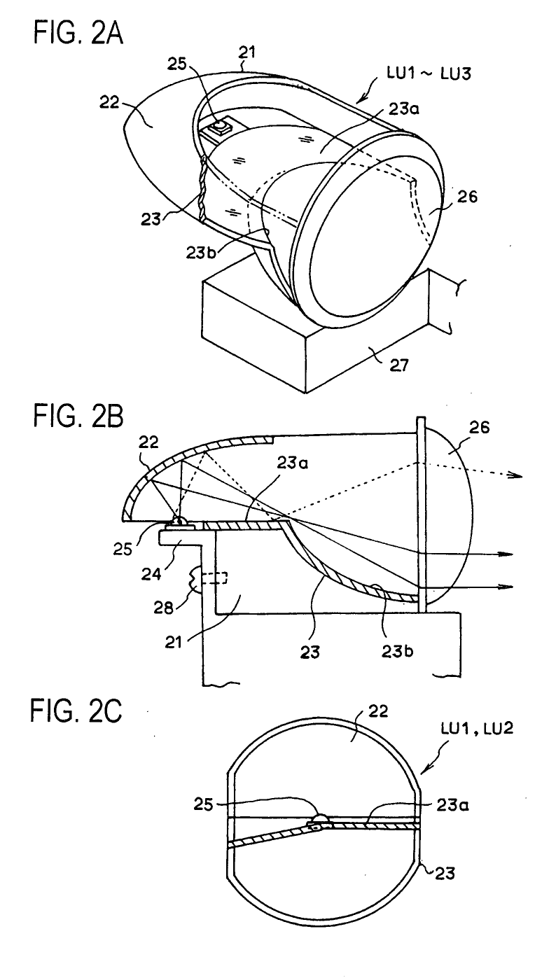

As seen from FIG. 2A, which is a partially-fractured schematic perspective view, each one of the three projector-type light source units LU1 to LU3 includes a reflector block 21; and in this reflector block 21, a main reflector 22 that is structured with a part of a rotational ellipsoid and a sub-reflector 23 that extends toward the front along the lower edge of the main reflector 22 are integrally structured. The sub-reflector 23 includes a flat portion 23a that is disposed substantially horizontally; and the area in front of the flat portion 23a is, as seen from FIG. 2B, a concave portion 23b that is curved downward in a concave shape, and no light is reflected on this concave portion 23b.

As shown in FIG. 2B, a vertically cross sectional view taken along the optical axis direction, the reflector block 21 includes a light emitting diode (LED) 25 that is attached to stem 24 and is used as a light source and a lens 26 that is attached to the front end portion of the reflector block 21 and is disposed so as to oppose the LED 25. The LED 25 is positioned at the first focal point of the main reflector 22. The sub-reflector 23 is positioned so that the border between the flat portion 23a and the concave portion 23b is positioned at a second focal point of the main reflector 22.

As shown in FIG. 1, the three light source units LU1 to LU3, arranged horizontally in a row, are fixed on and integrally formed with a bracket 27 that has a stepped configuration in the optical axial direction and also functions as a heat sink. The stem 24 is integrally formed with the bracket 27. By fixing the stem 24 onto the reflector block 21 with a screw 28 (see FIG. 2B), the reflector block 21 is fixed on the bracket 27 at the same time.

In each of the light source units LU1 to LU3, the light emitted by the respective LEDs 25 is reflected by the inner surface of the main reflector 22; and after being condensed at the second focal point, the light is condensed by the lens 26 and is radiated forward. Furthermore, as shown by the broken lines in FIG. 2B, a part of the light reflected by the main reflector 22 is reflected by the flat portion 23a of the sub-reflector 23, then condensed by the lens 26 and radiated forward.

As seen from the above, it is possible to effectively use the light emitted by the LEDs 25 as illumination light and improve the radiation efficiency.

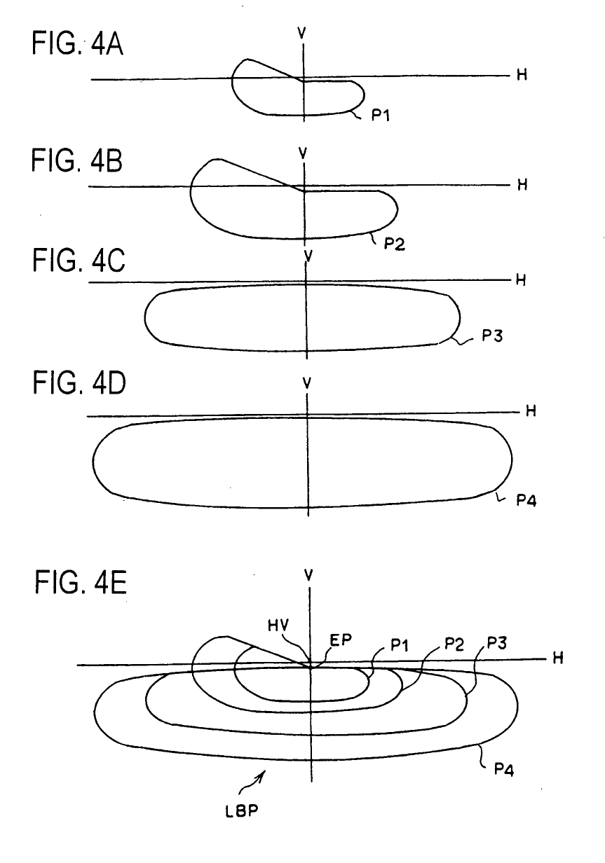

In the shown embodiment, of the three projector-type light source units LU1 to LU3, the first light source unit LU1 that is provided closest to the center of the automobile within the lamp chamber 13 is formed, as seen from FIG. 2C that shows the light source unit LU1 viewed from the front, such that the area on the left side as viewed from the front of the flat portion 23a of the sub-reflector 23 has a shape slightly slanted downward. Accordingly, it is possible for the light source unit LU1 to radiate a part of the light, which is reflected by the flat portion 23a after been reflected by the main reflector 22, into the left upper direction above the horizontal line and to impart a required or predetermined light distribution characteristic having a horizontal cut line and an oblique cut line; and as a result, as seen from FIG. 4A, the light source unit LU1 provides a light distribution pattern in which the light is condensed in a small area that includes the lamp center (or the center of the lamp).

The second light source unit LU2 positioned next to the first light source unit LU1 is configured in the same manner as the first light source unit LU1, and it provides a light distribution pattern having a horizontal cut line along the horizontal line H and an oblique cut line along which the light is radiated into an upper left direction above the horizontal line; and as shown in FIG. 4B, the light distribution pattern P2 by the second light source unit LU2 is configured such that the radiation area below the horizontal line H is larger than the area radiated by the first light source unit LU1.

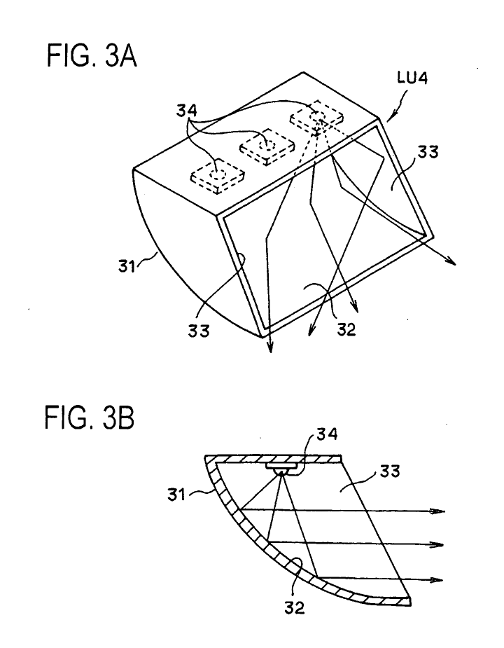

On the other hand, in the third light source unit LU3, the flat portion 23a of the sub-reflector 23 has a flat plane shape in a horizontal direction for its entirety, and, unlike the first and second light source units LU1 and LU2, the third light source unit LU3 does not have a downwardly slanted area. Accordingly, the sub-reflector 23 of the third light source unit LU3 generates no light that is radiated into the upper left direction above the horizontal line H; and, as shown in FIG. 4C, the third light source unit LU3 provides a light distribution pattern that has only a horizontal cut line so that an even larger area is radiated than the area radiated by the light source unit LU2 As shown in FIGS. 3A and 3B, the diffusion-type light source unit LU4 of the low-beam lamp LBL of the right-side headlamp RHL is comprised of a multi-faced reflector 31 that includes a main reflector 32 and a sub-reflectors 33. The main reflector 32 has a curved shape of a parabolic cylinder along the lower lateral face, and the sub-reflectors 33 are respectively formed in the shape of an elevation surface slanted in the horizontal direction with respect to the optical axis and are integrally formed with the main reflector 32 on the left and right sides in the cylinder axial direction. Three LEDs 34 are provided in a row on the focal axis of the main reflector 32 that extends in the horizontal direction. A flat-plate lens 35 is, as seen in FIG. 1, attached to the front side of the multi-faced reflector 31.

In the diffusion-type light source unit LU4 thus structured, the light emitted by each of the LEDs 34 is reflected by the main reflector 32 so that the light is parallel in the up-and-down direction but is diffused in the left-and-right direction as seen from FIGS. 3A and 3B, and the light diffused in the left-and-right direction is reflected forward by the sub-reflectors 33 provided on both sides of the main reflector 32; and all of the reflected light beams are radiated forward after passing through the flat-plate lens 35.

With the arrangements described above, as shown in FIG. 4D, a light distribution pattern P4 is configured by the diffusion-type light source unit LU4 in which the light is diffused in a large area on the left and right sides along and beneath the horizontal line H.

In the above-described embodiment, four light source units LU1 to LU4 are integrally formed with one another with the bracket 27; and with the use of a swivel mechanism (not shown), it is possible to tilt the bracket 27 in a horizontal direction so that the radiation direction of the low-beam lamp LBL comprised of light source units LU I to LU4 faces left and right.

When the four light source units LU1 to LU4 are caused to emit light, the light beams emitted from the light source units LU1 to LU4 are combined together, and a low-beam pattern LBP as shown in FIG. 4E is formed by the light distribution patterns P1 to P4. In the low-beam light distribution pattern LBP, especially in the proximity of the horizontal and oblique cut lines, the illumination with high-intensity light is provided by the light distribution pattern P1 of the first light source unit LU1. The area of the light distribution pattern P1 having high-intensity light is defined as what is called a “hot zone.” The optical axis of the first light source unit LU1 that forms the hot zone, i.e. the optical axis that passes through the light emission point of the LED 25 serving as the light source, is the optical axis of the hot zone. Generally, in the low-beam light distribution pattern, an intersection point of the horizontal cut line and the oblique cut line on the left is recognized as an elbow point EP as shown in FIG. 4E. However, the hot zone is an area surrounding the elbow point EP.

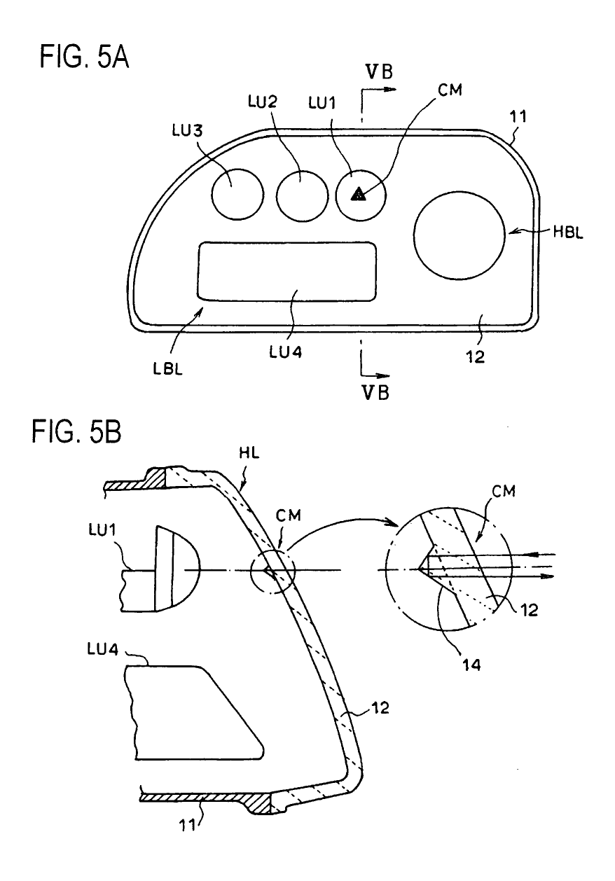

As shown in FIG. 5A, which is a schematic front view of the right-side headlamp RHL, the position at which the optical axis of the light source unit LU1 that forms the hot zone intersects the transparent cover 12 (the optical axis of the light source unit LU1 being within the light emission area of the light source unit LU1) is set to be (or specified) as a “lamp center,” and a small center mark CM is provided at this position. The center mark CM is a reflective member; and in the shown embodiment, as seen from FIG. 5B, which is an enlarged cross sectional view taken along the line VB-VB in FIG. 5A, the reflective member 14 is in the shape of an equilateral triangular pyramid and has a light-transmission characteristic, and the bottom face thereof is adhered in close contact with the inner surface of the transparent cover 12. Alternatively, the reflective member 14 can be integrally formed with the transparent cover 12. The reflective member 14 has the same configuration as what is called a “reflex reflector” that is widely used as a reflective marker for automobiles.

Though not shown in the drawing, as a substitute for the reflective member described above, the reflective member 14 can be in an arbitrary shape and made of a light reflective material such as aluminum so as, at the above-described intersection position on the inner surface of the transparent cover 12, to be integrally pasted thereto or integrally formed therewith using a method like evaporation or coating, as long as the reflective member 14 does not affect the light distribution characteristics of the lamp.

FIG. 6 shows a head light testing apparatus HLTST that checks to see if the light distribution pattern of a lamp satisfies a predetermined or required standard or not when the headlamp of the shown embodiment is mounted to an automobile (the description of the test will be made for the left-side headlamp that has the same configuration as the right-side headlamp of the above described embodiment; and in the left-side headlamp the arrangement of the light source units LU1 to LU3 is symmetrical with the arrangement of the light source units of the right-side headlamp).

An automobile (“CAR” in FIG. 6) to which the headlamp HL to be tested is mounted is parked at a predetermined position in front of the, head light testing apparatus HLTST. The testing apparatus HLTST is comprised of an X-axis bar 101 that is installed horizontally so as to be perpendicular to the longitudinal direction of the automobile, and both ends of the X-axis bar 101 are supported by supporting columns (not shown). A Y-axis bar 102 that is disposed vertically (i.e. an up-and-down direction) is suspended from the X-axis bar 101 via an X-axis driving mechanism 103, so that the Y-axis bar 102 is movable in the horizontal direction along the X-axis bar 101. An imaging device 110 such as a CCD (charge-coupled device) imaging device is provided on the Y-axis bar 102 via a Y-axis driving mechanism 104, so that the imaging device 110 is movable in an up-and-down direction along the Y-axis bar 102. Each of the X-axis driving mechanism 103 and the Y-axis driving mechanism 104 uses a motor or the like as the driving power source and is electrically connected to a controller 120. The X-axis driving mechanism 103 and the Y-axis driving mechanism 104 are moved in the X direction and in the Y direction, respectively, by servo control of the controller 120, thus controlling and moving the imaging device 110 to an arbitrarily selected position in the up-and-down and the left-and-right directions. A screen SC is installed behind the imaging device 110, so that a light distribution pattern of the headlamp HL can be visually recognized by allowing the light to be actually emitted from the headlamp HL onto the screen SC. The screen SC can be omitted in the test.

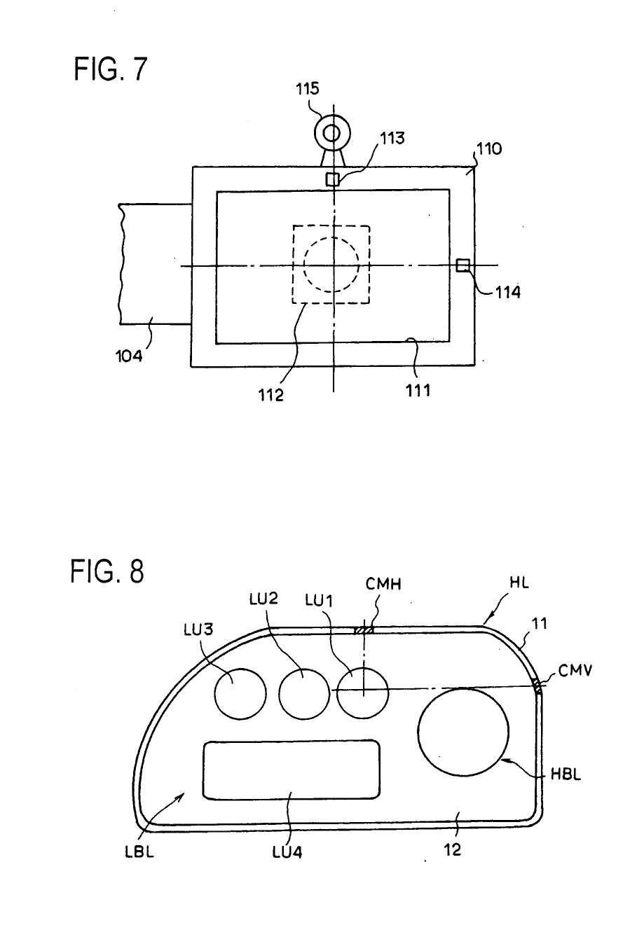

As shown in FIG. 7, the imaging device 110 has a light receiving window 111 of a rectangular shape, and it receives light radiated from either one of the headlamps HL of the automobile CAR; and an imaging camera or an imaging element 112 is also provided in the imaging device 110 so that it is disposed behind (see FIG. 6) the light receiving window 111. The imaging device 110 takes an image of the light from the headlamp HL that has been received through the light receiving window 111 and outputs an imaging signal to the controller 120. The controller 120 performs signal processing on the imaging signal and thus recognizes a light distribution pattern of the headlamp received through the light receiving window 111. Though an explanation on the algorithm used to process the light distribution pattern is omitted, it is possible, for instance, to recognize the light distribution pattern by distinguishing the radiated areas and non-radiated areas through binarization of the signal level in each pixel based on a predetermined threshold value on the imaging signal obtained in the imaging process and performing pattern recognition after putting the radiated areas together.

In the shown imaging device 110, in order to recognize the lamp center, i.e. the center mark CM, a vertical laser beam emitter 113 and a horizontal laser beam emitter 114 are provided. The vertical laser beam emitter 113 is installed on the upper center portion of the imaging device 110 in the lateral direction, and the horizontal laser beam emitter 114 is installed on the right side portion of the center of the imaging device 110 in the vertical direction. The vertical laser beam emitter 113 emits a laser beam flux that is in the form of a line and diffuses with a required width in the vertical direction. The horizontal laser beam emitter 114 emits a laser beam flux that is in the form of a line and diffuses with a required width in the horizontal direction.

When the head light test is performed on the headlamp HL using the head light testing apparatus HLTST as described above, as shown in FIG. 6, the automobile CAR is parked at such a position that one (left-side) of the headlamp of the automobile CAR to be tested faces the imaging device 110.

First, a lamp center detecting step for the headlamp HL is performed. In this lamp center detecting step, a laser beam is emitted from the vertical laser beam emitter 113 of the imaging device 110 and is projected on the headlamp HL. At the same time, the imaging device 110 takes an image of the headlamp HL. Then, the Y-axis bar 102 is moved in the horizontal direction along the X-axis bar 101 by the X-axis driving mechanism 103. The laser beam that has been emitted from the vertical laser beam emitter 113 and diffuses in the vertical direction is scanned in the horizontal direction on the surface of the transparent cover 12 on the headlamp HL. An image of a strong reflected beam obtained from the center mark CM when the laser beam is scanned on the center mark CM is taken by the imaging device 110. The controller 120 is thus able to detect the position of the center mark CM with respect to the left-and-right or horizontal direction by recognizing the position having the high level of light reception based on the imaging signal taken by the imaging device 110. Next, a laser beam is emitted from the horizontal laser beam emitter 114 of the imaging device 110 and is projected onto the headlamp HL; and at the same time, the imaging device 110 takes an image. Then, the imaging device 110 is moved in the up-and-down direction along the Y-axis bar 102 by the Y-axis driving mechanism 104. The laser beam that has been emitted from the horizontal laser beam emitter 114 and diffuses in the horizontal direction is scanned in the up-and-down direction over the transparent cover 12 of the headlamp HL. An image of the strong reflected beam obtained from the center mark CM when the laser beam is scanned on the center mark CM is taken by the imaging device 110. The controller 120 thus detects the position of the center mark CM with respect to the up-and-down or vertical direction by recognizing the position having the high level of light reception based on the imaging signal taken by the imaging device 110. The controller 120 moves the X-axis driving mechanism 103 and the Y-axis driving mechanism 104 by exercising servo control, so that the imaging device 110 is positioned directly opposite the recognized center mark CM, and the optical axis of the imaging device 110 is thus aligned with the center mark CM. As a result, the optical axis of the imaging device 110 is set to a position where the optical axis is positioned directly opposite the center mark CM provided on the headlamp HL. This means that the optical axis of the imaging device 110 is automatically positioned directly opposite the lamp center of the headlamp HL, i.e. automatically positioned directly opposite a light distribution center HV (see FIG. 4E) of the light distribution pattern.

Subsequently, a light distribution pattern testing step is performed. In the light distribution pattern testing step, judgment is made whether a cut-off line in the light distribution pattern forms a predetermined pattern with respect to the lamp center. Various algorithms can be used in making the judgment. However, for example, as described above, it is possible to recognize the light distribution pattern by distinguishing the radiated areas and non-radiated areas through binarization of the signal level in each pixel based on a predetermined threshold value, about the imaging signal obtained by taking the image of the light beam radiated onto the light receiving window 111 of the imaging device 110 with the imaging camera 112, after putting the radiated areas together on the imaging signal obtained in the imaging process and performing pattern recognition. It is possible to perform a test and judge if the light distribution pattern is correct by judging whether the recognized light distribution pattern satisfies a required or predetermined distribution of luminance with respect to the optical axis of the imaging device, i.e. the lamp center of the headlamp HL, in other words, with respect to the elbow point EP.

As described above, in the above embodiment of the present invention, since the center mark CM that is the reflective member 14 is disposed at the lamp center position on the transparent cover 12 provided at the front part or opening of the lamp body 1 of the headlamp HL, it is possible to detect the center mark CM by using the reflection of the laser beams emitted from the vertical and horizontal laser beam emitters 113 and 114 of the imaging device 110. Consequently, even if a headlamp includes a plurality of (e.g. four) light source units such as those LU1 to LU4 as in the shown embodiment, it is possible to detect, with a high level of precision, the lamp center of the headlamp HL and align it with the optical axis of the imaging device 110 or to align the optical axis of the head light testing apparatus HLTST with the elbow point EP in the light distribution pattern, thus allowing the subsequent test of the light distribution pattern to be performed accurately.

Though not shown in the drawings, instead of providing the vertical laser beam emitter 113 and the horizontal laser beam emitter 114 on the imaging device 110 as in the above description, another configuration can be taken so that only one laser beam emitter scans in both vertical and horizontal directions. In this single emitter structure, the laser beam emitter emits to scan a laser beam in, for instance, the vertical direction while the Y-axis bar 102 is moved left-and-right, horizontal, direction along the X-axis bar 101, thus scanning the front face of the headlamp with the emitted vertical laser beam and detecting the center mark CM based on the imaging signal obtained in the imaging process performed by the imaging device 110. It is also possible to cause the laser beam emitter to emit to scan a laser beam in the horizontal direction while the imaging device 110 is moved in the up-and-down, vertical, direction along the Y-axis bar 102, so that the front face of the headlamp is scanned with the emitted horizontal laser beam and the center mark CM is detected based on the imaging signal.

In the above described embodiment, the center mark CM (reflective member 14) is provided at the lamp center position on the transparent cover 12 of the headlamp HL. However, when there is a possibility that the reflective member 14 for structuring the center mark CM would affect the light distribution pattern, the center mark can be disposed outside the translucent area of the transparent cover 12. Especially in a multi light-source type headlamp that includes a plurality of light source units using semiconductor light emitting elements as the light source, as in the above embodiment, the luminance of the radiated light beam emitted from each of the light source units is lower than the case where an incandescent bulb or a discharge bulb is used; and thus, the effect that the center mark has on the light distribution pattern is not negligible.

To cope with this situation, in the structure shown in FIG. 8, a horizontal guide mark CMH indicative of the horizontal position of the lamp center and a vertical guide mark CMV indicative of the vertical position of the lamp center are provided respectively on the upper edge portion and on the right edge portion of the transparent cover 12 of the headlamp HL. The horizontal guide mark CMH and the vertical guide mark CMV can be formed by reflective members as in the embodiment described above.

When detecting a lamp center using the guide marks CMH and CMV, as in the same manner as shown in the above description, the laser beam emitted from the imaging device 110 of the head light testing apparatus HLTST is reflected by the horizontal guide mark CMH and the vertical guide mark CMV, and an image of the reflected beams is taken by the imaging device 110. Then, an intersecting point of a line extending vertically from the detected horizontal guide mark CMH and a line extending horizontally from the detected vertical guide mark CMV is detected as a lamp center. The operation that is performed after the lamp center has been detected is the same as that in the description above.

Because the horizontal guide mark CMH and the vertical guide mark CMV are provided at edge portions of the transparent cover 12 through which valid illumination light is unable to pass, the light distribution pattern is not affected even in a multi light-source type headlamp. In addition, since there is no center mark, which is made of a reflective member, in the translucent area of the transparent cover 12, no center mark is seen when the headlamp HL is viewed from the outside, and thus, the exterior appearance of the headlamp HL is not degraded.

The above-described reflective member 14 (see FIGS. 5A and 5B), or the center mark CM, can be a reflective member that has a predetermined chromatic color.

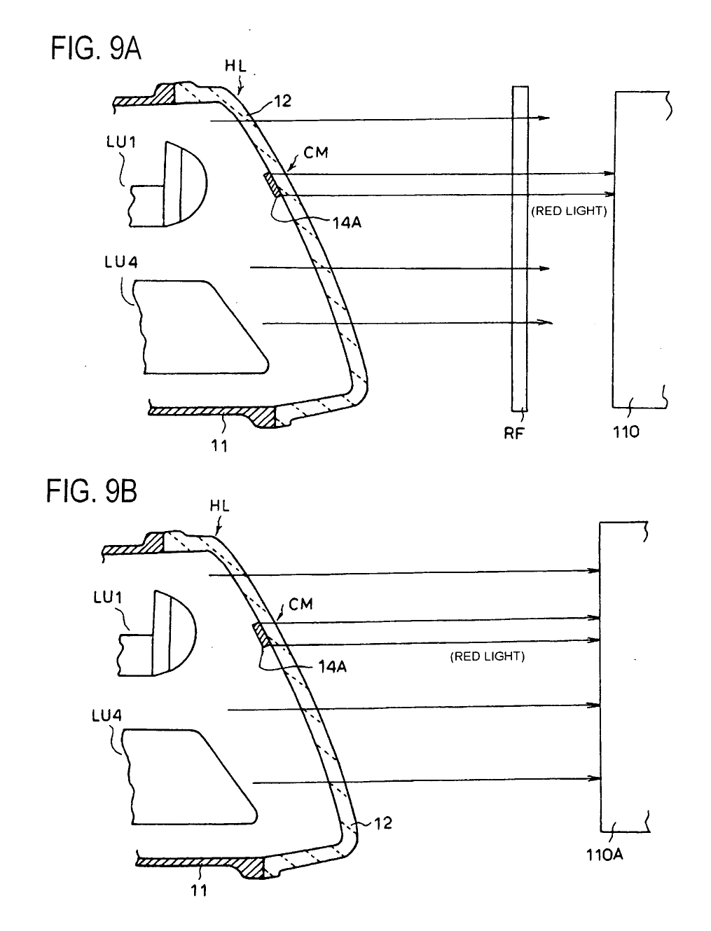

More specifically, in the structure of FIG. 9A, a small reflective member 14A that is a circular-shaped or rectangular-shaped sticker is provided on the inner surface of the transparent cover 12 of the headlamp HL so as to be a center mark CM. The reflective member 14A, in this structure, is a red reflective member that reflects red light. The imaging device 110 of the head light testing apparatus HLTST used for this lamp is provided with, as its light source (not shown), for example, an incandescent lamp that radiates white light instead of laser beam emitters, so that the white light is radiated onto substantially the entire area of the transparent cover 12 of the headlamp HL, and a color filter that has the same color as the red reflective member 14A, i.e. a red-colored filter RF, is disposed in front of the imaging device 110.

With this arrangements, when white light is projected onto the headlamp HL from the imaging device 110 side, light in red is reflected by the red reflective member 14A that is the center mark CM, and in the other area white light, from which the light energy is more or less absorbed by the transparent cover 12 and by the inside of the lamp body 11, is reflected. As a result, the red reflected light from the center mark CM passes through the red color filter RF while having a large quantity of light, and the other white light has a lowered quantity of light. As a result, red light within the white light has a large quantity of light; and thus, when an image of the reflected light is taken by the imaging device 110, the image shows a point with high luminance in the surrounding area of low luminance. As a result, it is possible to detect the point having the high luminance as the center mark CM.

In the structure of FIG. 9A, since there is, within the image obtained in the imaging process, a large difference between the luminance of the center mark CM and the luminance in the other area, it is possible to detect the center mark CM of the lamp easily.

FIG. 9B shows another way to detect the center mark. In the system of FIG. 9B, instead of providing a red color filter RF in front of the imaging device, a color imaging device 110A that includes a color imaging element as its imaging element is employed.

In the detecting process of FIG. 9B, white light is radiated onto the headlamp HL, and the image of the reflected light is taken with the color imaging device 110A. Since the image taken by the color imaging device 110A includes a red point in the surrounding white area, it is possible to detect this red point as the center mark CM. In the system of FIG. 9B, it is possible to detect the center mark CM and the other area based on the differences in color within the image obtained in the imaging process; accordingly, it is even easier to detect the center mark of the lamp.

In the systems of FIGS. 9A and 9B, the reflective member 14A is a red reflective member. However, a reflective member of any other chromatic color than red can be used; and in such a case, the color filter or the color imaging element used with the imaging device 110 or 110A is indeed of the same color as the chromatic-color of the reflective member.

In the meantime, actual automobile testing sites may not have an automatic head light testing apparatus HLTST as shown in FIG. 6. In such a situation, it is not possible to automatically detect the lamp center with the imaging device of the automatic head light testing apparatus HLTST, and thus a manual testing apparatus is instead used in which the optical axis of an imaging device needs to be aligned with a lamp center manually. Such a manual testing apparatus is generally not equipped with the Y-axis bar nor the servo mechanism that operates the imaging device of the head light testing apparatus HLTST shown in FIG. 6. As a result, the position of the imaging device in the up-and-down vertical direction and the left-and-right horizontal direction is adjusted manually, and a controller connected to the imaging device does not include algorithm used for detecting the center mark based on the image taken.

In order to align the optical axis of the imaging device with a lamp center of a headlamp using such a manual testing apparatus, an alignment device 115 having an optical axis parallel to the optical axis of the imaging device 110, as best shown in FIG. 7, is used. An operator looks into the alignment device 115 and visually finds the center mark CM of the headlamp HL and then aligns the optical axis of the imaging device 110 so that the imaging device 110 is positioned to directly face the lamp center of the headlamp HL by aligning the optical axis of the alignment device 115 with the center mark of the lamp.

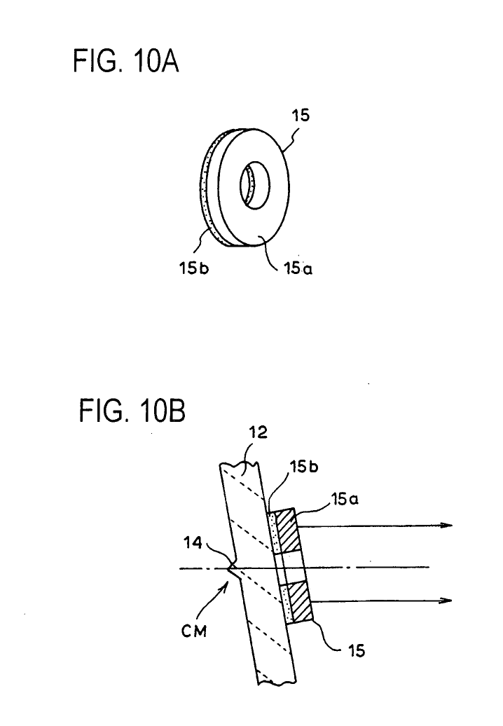

In such a manual testing apparatus as described above, if the center mark CM provided on the transparent cover 12 on the headlamp HL is a reflective member 14 which is a small transparent member as shown in FIGS. 5A and 5B, it is difficult to visually find the center mark CM by looking into the alignment device 115. Accordingly, so as to overcome this problem, in the present invention, a reflection assisting member 15 as shown in FIG. 10A is temporarily pasted on the surface of the transparent cover 12 of the lamp at a position that opposes or faces the center mark CM.

The reflection assisting member 15 is an annular plate (or is of a doughnut shape) having predetermined outside and inside diameters. The front surface of the reflection assisting member 15 is a reflecting surface 15a, and its rear surface is an adhesive layer 15b made of, for instance, a layer of double-sided tape. The reflecting surface 15a of the reflection assisting member 15 is formed from a reflective plate having a reflex reflector structure described above with reference to the power source units LU1 to LU4. Alternatively, the reflecting surface 15a can be formed with a reflective plate made of aluminum or the like. In addition, the reflecting surface 15a can be colored in red or the like so that it is easy for the operator to visually find the reflection assisting member 15. Further, the adhesive layer 15b on the rear surface of the reflection assisting member 15 can be in the form of a suction disk or the like so that it is possible to make the reflection assisting member 15 temporarily adhere to the surface of the transparent cover 12 of a lamp.

The above-described reflection assisting member 15 is mounted on the outer surface of the front face of the transparent cover 12 as shown in FIG. 10B. More specifically, before performing a head light test, an operator visually finds the center mark CM of the headlamp HL and pastes the reflection assisting member 15 on the front face of the transparent cover 12 so that the center mark (the reflective member 14) CM is surrounded, with the transparent cover 12 in between, by the reflection assisting member 15 as shown in FIG. 10B.

When performing the test using the manual testing apparatus, the operator looks into the sighting device 115 of the imaging device 110 and visually finds the reflection assisting member 15. Then, the operator aligns the optical axis of the imaging device 110 with the reflection assisting member 15 by manually moving the imaging device 110 in the horizontal and/or vertical directions. When the optical axis of the imaging device 110 is aligned with the center of the reflection assisting member 15, the optical axis of the imaging device 110 is positioned directly opposite the center mark CM and faces the center mark CM. The remaining steps of the head light test is the same as those in the tests described above, so that the headlamp is lit, an image is taken with the imaging device, and a light distribution pattern is checked by performing the signal processing on the image obtained in the imaging process.

In the above description, the lamp center is recognized by the reflection assisting member 15 that has a larger outside dimension than the reflective member 14 which is the center mark CM. Therefore, the operator can easily align the optical axis of the testing apparatus by visually finding the lamp center. When the reflection assisting member 15 is formed so as to reflect light of a desired color, the visual recognition can be done even more easily.

When the reflective assisting member 15 is used, the center mark provided on the transparent cover of a lamp does not need to be formed by a reflective member, and any simple mark can be used as long as long as the operator is able to use the mark as a marker when determining the position at which the reflection assisting member 15 is pasted on the headlamp HL.

In the above descriptions, one light source unit out of the multiple (four) light source units of the headlamp forms the hot zone. However, when two or more light source units form a hot zone, then the center position of the light emission area of such two or more light source units is specified as a lamp center.

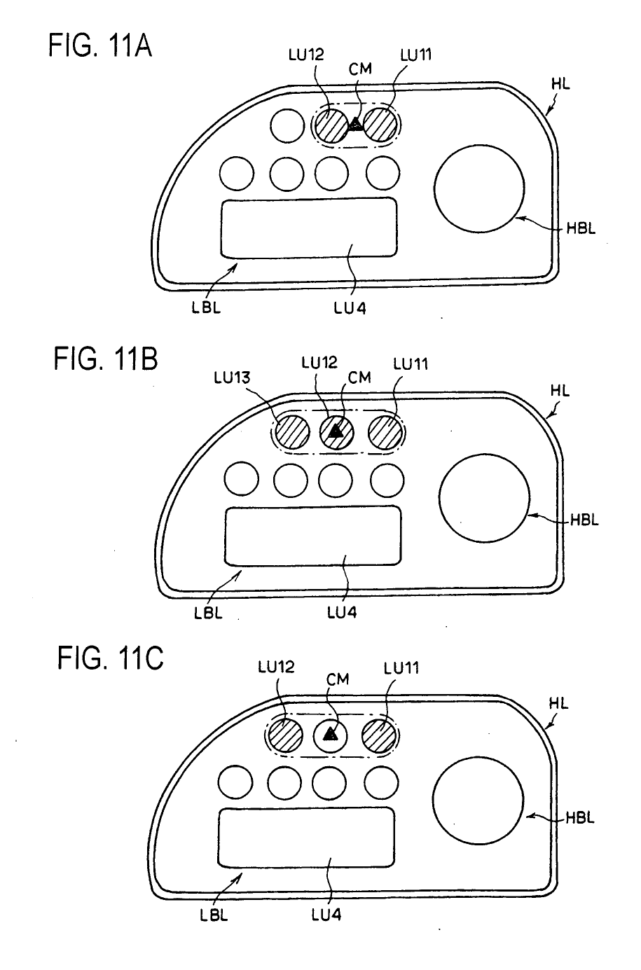

More specifically, in the structure of FIG. 11A, two, for instance, light source units LU11 and LU12 that form a hot zone are arranged in a row in a vertical or horizontal direction; and thus, the light emission area of the light source units LU11 and LU12 forms a single joined area shown by the dashed-dotted lines, and the center position of this light emission area is set to be the lamp center, so that a center mark CM is provided at a point on the surface of the transparent cover of the lamp that directly opposes or faces this lamp center.

When, as shown in FIG. 11B, three light source units LU11, LU12 and LU13 that form a hot zone are arranged in a row horizontally and the light emission area shown by the dashed-dotted lines is horizontally symmetric, then the position of the optical axis of the light source unit LU12 which is in the middle of the three light source units is set to be a lamp center, and a center mark CM is provided at a point on the the surface of the transparent cover of the lamp to which the optical axis of the light source unit LU12 intersects the transparent cover.

Furthermore, when, as shown in FIG. 11C, two light source units, for instance, the light source units LU11 and LU12, or three or more light source units, that form the hot zone are installed apart from one another, then an area in which such plurality of light source units, for instance, the light source units LU11 and LU12, are provided (when viewed from the front) forms the light emission area shown by the dashed-dotted lines, and the center of this light emission area is set to be a lamp center, so that a center mark CM is provided at a point on the surface of the transparent cover of the lamp that directly opposes or faces the lamp center. In this example of FIG. 11C, the two light source units LU11 and LU12 are separated from each other. Even if the light emission area obtained by the combination of these two light source units LU11 and LU12 does not form a single joined area indicated by the dashed-dotted lines, the center of the light emission areas or the mid point between the two light source units is set as a lamp center.

Though not shown in the drawing, when a plurality of light source units have noticeable differences in luminance, a luminance center position obtained considering the luminance differences of these light sources is set as a lamp center. In any of the above structures, the center mark is provided at the corresponding position of the lamp center or, alternatively, a mark with which the lamp center is recognizable is provided on the front face (front cover) of the headlamp.

In the embodiments described above, the present invention is applied to a headlamp that forms a low-beam light distribution pattern. However, it is possible to apply the present invention in the same manner to the case in which the position of the optical axis of a lamp is detected in order to test the light distribution characteristics of a multi light-source type lamp; and in this case, the light source unit that forms a hot zone can be a light source unit that illuminates, with a high luminance, a relatively small area including the optical axis of the lamp.

1. A vehicular headlamp comprising a plurality of light source units having respectively a light emitting element as a light source thereof and being configured so as to provide a predetermined light distribution pattern by combining illumination light beams respectively emitted from said plurality of light source units, wherein:
at least one of said plurality of light source units forms a hot zone in said light distribution pattern;
a lamp center is provided within a light emission area of said at least one of said plurality of light source units that forms said hot zone; and
said vehicular headlamp is further provided with a center mark indicative of said lamp center.

2. The vehicular headlamp according to claim 1, wherein
at least one of said plurality of light source units is a low-beam lamp, and
said hot zone is an area surrounding an elbow point within a low-beam light distribution pattern of said vehicular headlamp.

3. The vehicular headlamp according to claim 1, wherein
one of said plurality of light source units forms said hot zone; and
said lamp center is provided substantially at a center of a light emission area of said one of said plurality of light source units.

4. The vehicular headlamp according to claim 2, wherein
one of said plurality of light source units forms said hot zone; and
said lamp center is provided substantially at a center of a light emission area of said one of said plurality of light source units.

5. The vehicular headlamp according to claim 1, wherein
said hot zone is formed by two or more of said plurality of light source units; and
said lamp center is provided substantially at a center of a light emission areas of said two or more of said plurality of light source units.

6. The vehicular headlamp according to claim 2, wherein
said hot zone is formed by two or more of said plurality of light source units; and
said lamp center is provided substantially at a center of a light emission areas of said two or more of said plurality of light source units.

7. The vehicular headlamp according to claim 1, wherein
said light source unit forming said hot zone is a projector-type light source unit that has a lens thereon; and
said lamp center is provided at a substantially center portion of a front face of said lens of said projector-type light source unit.

8. The vehicular headlamp according to claim 4, wherein
said light source unit forming said hot zone is a projector-type light source unit that has a lens thereon; and
said lamp center is provided at a substantially center portion of a front face of said lens of said projector-type light source unit.

9. The vehicular headlamp according to claim 6, wherein
said light source unit forming said hot zone is a projector-type light source unit that has a lens thereon; and
said lamp center is provided at a substantially center portion of a front face of said lens of said projector-type light source unit.

10. The vehicular headlamp according to claim 1, wherein said center mark is comprised of a reflective member provided on a front face of said vehicular headlamp and at a position that corresponds to said lamp center.

11. The vehicular headlamp according to claim 1, wherein
a plurality of guide marks are provided in a perimeter area of a front face of said vehicular headlamp; and
said lamp center is set at an intersection point of line segments that pass through said guide marks.

12. The vehicular headlamp according to claim 10, wherein
a plurality of guide marks are provided in a perimeter area of a front face of said vehicular headlamp; and
said lamp center is set at an intersection point of line segments that pass through said guide marks.

13. The vehicular headlamp according to claim 1, wherein said center mark is a marking member which is attachable on and detachable from a front face of said vehicular headlamp.

14. The vehicular headlamp according to claim 10, wherein said center mark is a marking member which is attachable on and detachable from a front face of said vehicular headlamp.
